(19) United States
(12) Patent Application Publication
(10) Pub. No.: US 2004/0259756 A1
(43) Pub. Date: Dec. 23, 2004

(54) Process for preparing and using active shaped bodies

(76) Inventors: Thomas Klein, Koln (DE); Alfred Mitschker, Odenthal (DE); Holger Schmidt, Dormagen (DE)

Correspondence Address: LANXESS CORPORATION, PATENT DEPARTMENT/ BLDG 14, 100 BAYER ROAD, PITTSBURGH, PA, 15205-9741, US

(21) Appl. No.: 10/873,059

(22) Filed: Jun. 21, 2004

(30) Foreign Application Priority Data
Jun. 20, 2003 (DE) 10327682.3

(51) Int. Cl. C11D 17/00

(52) U.S. Cl. 510/446

(57) ABSTRACT

The present invention relates to washing- or cleaning-active shaped bodies, in particular tablets such as detergent tablets, dishwashing tablets, stain removal tablets or water softening tablets, comprising polysuccinimide in combination with polyethylene glycols and/or phosphoric acid.

### BACKGROUND OF THE INVENTION

1. Field of the Invention

The invention relates to washing- or cleaning-active shaped bodies, primarily tablets, such as detergent tablets, dishwashing tablets, stain removal tablets or water softening tablets and a process for preparing and using the same. More specifically, the invention relates to washing or cleaning tablets comprising a combination of polysuccinimide in with polyethylene glycol and/or phosphoric acid, and a process for preparing, and using the same, in particular for machine use.

2. Brief Description of the Prior Art

Washing- or cleaning-active shaped bodies, in particular tablets, have a number of advantages over pulverulent compositions, such as advantageous handling, simple dosing and low packaging volume requirement. However, the use these tablets is attended by problems which arise from the fact that relatively high compressive forces have to be applied during compression of the pulverulent constituents in order to achieve adequate dimensional stability and fracture resistance. Due to the high compression, the tablets often have inadequate disintegration and dissolution properties in use. Consequently, the active substance in the tablets used as detergent or cleaner is released too slowly, giving rise in particular to the risk of residues forming on textiles following the wash cycle.

The following are examples of materials that have been used to prepare active shaped bodies and their associated disadvantages. Polysuccinimide is an ideal constituent of washing- or cleaning-active shaped bodies since, upon contact with alkali, it forms the dispersant polyaspartate. The great advantage of polysuccinimide is its very low hygroscopicity since it completely lacks both functional groups which form ionic bridges or form hydrogen bridges. As such the admixing of hygroscopicity-reducing substances, such as hydrophobically modified silicon dioxide or magnesium stearate, can thus be avoided. The hygroscopicity of partially hydrolzed PSI of the kind produced by reacting PSI with water or NaOH in substoichiometric quantities (based on the succinimide units) lies midway between that of sodium polyaspartate and that of PSI and it can represent a compromise for washing and cleaning-active shaped bodies having requirements between rapid solubility and hygroscopicity. Partially hydrolyzed PSI is considerably more rapidly soluble in water than non-modified PSI.

However, in the use of polysuccinimide (PSI) in forming active shaped bodies, the problem of inadequate disintegration is compounded by its extremely slow solubility in water. Manifestly polysuccinimide has been used in the past in slow-release applications (see DE-A 11 01 671).

The problem of the slow disintegration of tablets with rapid dissolution of the ingredients in the field of detergents and cleaners has been known for a long time. According to the teachings of EP-B 0 523 099 and WO-A-96/06156, it is possible to use disintegrants which are known from the manufacture of pharmaceuticals. The disintegrants mentioned are swellable phyllosilicates, such as bentonites, natural substances and natural derivatives based on starch and cellulose, alginates and the like, potato starch, methylcellulose and/or hydroxypropylcellulose, but also microcrystalline cellulose, sugars, such as sorbitol. These disintegrants can be mixed with the granules to be compressed, but may also already be incorporated into the granules to be compressed.

According to EP-A-0 522 766, at least the particles which comprise surfactants and builders are coated with a solution or dispersion of a binder/disintegration auxiliary, in particular polyethylene glycol. Other binders/disintegration auxiliaries are again known disintegrants, for example starches and starch derivatives, commercially available cellulose derivatives, such as crosslinked or modified cellulose, microcrystalline cellulose fibers, crosslinked polyvinylpyrrolidones, phyllosilicates etc.

According to EP-A-0 711 827, the use of particles which consist predominantly of citrate which has a certain solubility in water also leads to accelerated disintegration of the tablets.

Said solutions contribute to an improvement in the disintegration properties of washing- or cleaning-active tablets in the detergent and cleaner sector. However, the improvement achieved is in many cases inadequate. In particular, if the proportion of tacky organic substances in the tablets, for example, of anionic and/or nonionic surfactants increases. Alternately ingredients of the shaped bodies, as in the case of PSI, is only very sparingly soluble in water. This is one of the reasons why, hitherto, there has been lacking commercially available detergent tablets formulated on the basis of PSI, which satisfy the stringent consumer requirements. Also, in the dishwashing detergent sector and in the detergent additives sector, tablets do not have the satisfactorily high disintegration rate despite having often satisfactory fracture resistance. Increasing the rate of disintegration and dissolution may also be advantageous in the dishwasher product sector, particularly for phases which contain active ingredients which are intended to be effective at the start of the cleaning process or at relatively low temperatures, as with PSI in the present case.

Accordingly, the object of the present invention was to provide washing- or cleaning-active shaped bodies which comprise polysuccinimide (PSI) and which do not have the abovementioned disadvantages. The objective was likewise to provide a process for the preparation of these improved washing- or cleaning-active shaped bodies based on PSI.

### SUMMARY OF THE INVENTION

It has now been found that the use of PSI in combination with polyethylene glycols (PEG) and/or phosphoric acid surprisingly leads to rapidly disintegrating washing- or cleaning-active shaped bodies although the latter substances are liquids. Surprisingly it was found that PEG and phosphoric acid are true solvents for polysuccinimide. Concentrated solutions in high molecular weight PEG (e.g. MW>2000 d (d=dalton)) solidify to give high-viscosity or even solid products which are readily tablettable. Contact between the solutions and water produces dispersions of PSI with water which exhibit high solubility as a result of the highly disperse distribution of the PSI particles.

### BRIEF DESCRIPTION OF THE DRAWING

FIG. 1 shows the amount of dissolved PSI as a function of the time, with the various curves representing

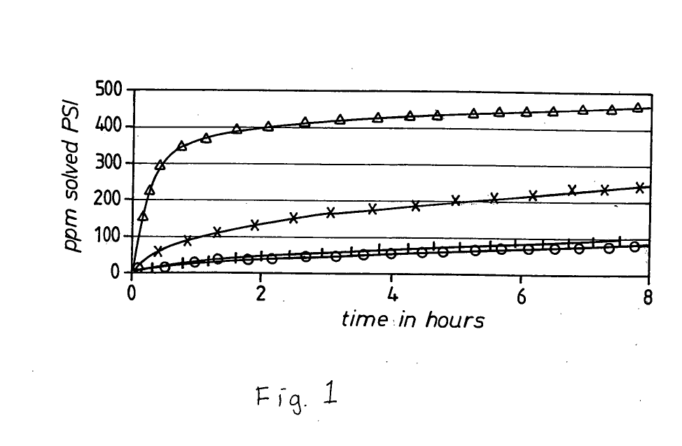

[symbol] Tabs with stearic acid at pH 8

[symbol] Tabs with stearic acid pH 10

[symbol] Tabs with alkyl PEG pH 8

[symbol] Tabs with alkyl PEG pH 10

### DETAILED DESCRIPTION OF THE INVENTION

In a first embodiment, the invention provides a washing- or cleaning-active shaped body comprising PSI and polyethylene glycol and/or phosphoric acid. In preferred embodiments, the compositions according to the invention comprise PSI in combination with PEG. In a further preferred embodiment, the compositions according to the invention comprise PSI and phosphoric acid.

In the course of the work carried out on the present invention it was found that PEG and phosphoric acid apparently act as solubilizers.

The washing or cleaning shaped bodies are primarily cylindrical configurations or tablets which may be used as detergents, dishwashing detergents, bleaching agents (stain removal salts), and optionally, as pretreatment agents, for example as water softeners or bleaching agents. However, the term “shaped body” is not restricted to the tablet shape. In principle, any three-dimensional shape which the starting materials can be made to assume, optionally by virtue of an external container, is possible. Cylindrical bodies here may have a height which is lesser or greater than or equal to the diameter of the base. Also conceivable, however, is an angular base, for example a rectangular base, in particular a square base, but also a rhombic or trapezoidal base, or a round or oval base of the shaped body. Further configurations include three-cornered or more than four-cornered bases of the shaped body.

Due to the excellent disintegration properties of the shaped bodies according to the invention, it is possible, but not absolutely essential, to introduce the shaped bodies directly into the aqueous liquor of a machine process by means of a dosing device; it is rather also possible to place the shaped body or the shaped bodies into the dispensing ring of commercially available domestic machines, in particular washing machines. Accordingly, in one preferred embodiment of the invention, the three-dimensional shape of the shaped bodies is adapted in its dimensions to the dispensing compartment of commercially available domestic machines.

In a preferred embodiment, the shaped body has a plate-like or slab-like structure with alternately thick long segments and/or thin short segments, so that individual segments can be broken off from this “bar” at the predetermined breaking points which the short thin segments represent, and introduced into the machine or the dispensing compartment of the machine. This principle of the “bar-shaped” composition can likewise be realized in other geometric shapes, for example vertical triangles which are only joined to one another longitudinally along one of their sides.

One preferred embodiment of the invention provides homogeneous or heterogeneous shaped bodies, in particular tablets, these tablets preferably having a diameter of from 20 to 60 mm, in particular 40+/−10 mm. The height of these tablets is preferably 10 to 30 mm and in particular 15 to 25 mm. The weight of the individual shaped bodies, in particular of the tablets, here is preferably 15 to 60 g and in particular 25 to 40 g per shaped body or tablet; the density of the shaped bodies or tablets, by contrast, usually has values above 1 kg/dm3, preferably from 1.1 to 1.4 kg/dm3. Depending on the type of application, the water hardness range or the soiling, 1 or more, for example 2 to 4, shaped bodies, in particular tablets, can be used. Further shaped bodies according to the invention may have even smaller diameters or dimensions, for example in the order of 10 mm.

A homogeneous shaped body is understood as meaning one in which the ingredients of the shaped body are distributed homogeneously. Accordingly, heterogeneous shaped bodies are understood as meaning those which do not have homogeneous distribution of their ingredients.

Heterogeneous shaped bodies can be produced, for example, by compressing the various ingredients not to give a uniform shaped body, but to give a shaped body which has several layers, i.e. at least two layers. In this connection, it is also possible for these various layers to have different disintegration and different dissolution rates. This may result in advantageous performance properties of the shaped bodies. If, for example, the shaped bodies contain ingredients which adversely affect one another, it is possible to integrate one component into the more rapidly disintegrating and more rapidly soluble layer, and to incorporate the other component into a more slowly disintegrating layer, so that the first component can act in advance or can have already completely reacted by the time the second component dissolves. The layer structure of the shaped bodies may be in the form of a stack, in which case a dissolution operation of the inner layer(s) can take place at the edges of the shaped body when the outer layers are still not completely dissolved or disintegrated; however, the inner layer(s) can also be completely surrounded by the layers which are in each case further to the outside, which prevents premature dissolution of the constituents of the inner layer(s).

In a further preferred embodiment of the invention, a tablet consists of at least three layers, i.e. two outer layers and at least one inner layer, with a peroxide bleaching agent being present in at least one of the inner layers, while in the case of the stack-like tablet, the two cover layers, and in the case of the shell-like tablet, the outermost layers are, however, free from peroxide bleaching agents. It is likewise possible to spatially separate peroxide bleaching agents and any bleach activators or bleach catalysts and/or enzymes from one another in a shaped body or tablet. Embodiments of this type have the advantage that even in cases where the detergent or bleaching agent shaped body or the detergent or bleaching agent tablet is placed in direct contact with the textiles in the washing machine or in the hand washing basin, there is no danger of spotting by bleaching agents and the like on the textiles.

Examples of heterogeneous shaped bodies can be found, for example, in European patent application EP-A-0 716 144, the contents of which are hereby incorporated into the present application.

PSI and its use as conditioning agent for stagnant and flowing water systems due to its dispersion properties, thermostability and hardness stabilizer properties are known from DE-A 101 01 671.

For the purposes of the present invention, PSI is understood as meaning PSI itself, its copolymers, partial hydrolyzates and its hydrolyzates. Partial hydrolyzates according to the present invention are polysuccinimides, whose polymer building blocks have been partially converted into aspartate units, i.e. copoymers of succinimide units and aspartate units. These partial hydrolyzates can also be present in a spray-granulated form.

PSI can be produced on an industrial scale by thermal polymerization of malefic anhydride and ammonia or derivatives thereof (see U.S. Pat. No. 3,846,380; U.S. Pat. No. 4,839,461; U.S. Pat. No. 5,219,952 or U.S. Pat. No. 5,371,180).

Moreover, PSI is obtained by thermal polymerization of aspartic acid (U.S. Pat. No. 5,051,401), optionally in the presence of acidic catalysts/solvents (U.S. Pat. No. 3,052,655).

PSI is produced during the chemical synthesis as a polymer with an weight average molecular weight of from 500 to 20 000, preferably 3000 to 5000. Polysuccinimide is to be regarded as a chemical precursor of polyaspartic acid, to which it slowly hydrolyzes with water. The pH of the resulting solution is between pH 1 and 4, preferably 2 and 3. As a result of this, not only does the good stone-dissolving effect come to fruition, but also at the same time the dispersing effect of the polyaspartic acid released by PSI toward sparingly soluble calcium salts or other sparingly soluble substances. The resulting acidic solution leads, due to its acidic effect, also to the direct dissolution of any calcium carbonate incrustations formed.

The PSI to be used according to the invention is in amounts of from 0.01 to 20% by weight, preferably 0.1 to 10% by weight and particularly preferably in amounts of from 0.5 to 5% by weight.

In the case of the use of polyethylene glycol (PEG) as solubility promoter, the PEG, preferably in an amount of 0.5-20% by weight.

Suitable polyethylene glycols are those with a high degree of ethoxylation, for example polyethylene glycols with a weight average molecular weight above 2000, preferably from 2000 to 12 000, particularly preferably from 2000 to 6000.

In the case of the use of phosphoric acid as solubility promoter, the phosphoric acid to be used according to the invention is used in an amount of from 0.5% by weight to 25% by weight.

The use of PEG and/or phosphoric acid surprisingly leads to rapid degradation of the PSI from the shaped bodies or the tablets into a water-soluble form, meaning that the use of PSI in detergents and cleaners is only possible as a result of this measure.

As well as the components PSI and PEG and/or phosphoric acid to be used according to the invention, it is possible to use further agents which aid dissolution of the tablets.

For example, so-called disintegrants are suitable for this purpose.

Preferred disintegrants which are to be converted into a granular or into cogranulated form include starch and starch derivatives, cellulose and cellulose derivatives, for example microcrystalline cellulose, CMC, MC, alginic acid and salts thereof, carboxymethylamylopectin, polyacrylic acid, polyvinylpyrrolidone and polyvinylpolypyrrolidone. The disintegrant granules can be produced conventionally, for example by spray-drying or superheated steam drying of aqueous preparation forms or by granulation, pelleting, extrusion or roll compaction. It may be of advantage here to add additives, granulation auxiliaries, carriers or laminating agents of the known type to the disintegrants (cogranulated form). In a preferred embodiment of the invention, additives are non-surface-active substances of detergents or cleaners, in particular bleach activators and/or bleach catalysts, particular preference being given here to disintegrant granules which comprise tetraacetylethylenediamine (TAED) and/or other bleach activators of the current type as additive. Such disintegrant granules can advantageously be prepared by cogranulation of the disintegrant with the additive. Cogranulation of this type may result in an increase in the distribution of the disintegrant in the shaped body, in particular in the tablet, which in certain cases may likewise lead to an improvement in the disintegration rate of the shaped body.

The useful amounts of such disintegrants are known to the person skilled in the art from DE-A 197 10 254, the contents of which are hereby incorporated into the present application.

Moreover, the washing- and cleaning-active shaped bodies according to the invention can comprise further constituents as are customarily used in detergents or cleaners and water softeners. These include primarily anionic, nonionic, cationic, amphoteric and zwitterionic surfactants, inorganic and organic, water-soluble or water-insoluble builder substances and cobuilders, bleaching agents, in particular peroxide bleaching agents, but also active chlorine compounds, which are advantageously coated, bleach activators and bleach catalysts, enzymes and enzyme stabilizers, foam inhibitors, graying inhibitors, substances which prevent the resoiling of textiles, so-called soil repellents, and also customary inorganic salts such as sulfates, and organic salts such as phosphonates, optical brighteners and dyes and fragrances. In machine dishwashing detergents, the use of conventional silver protectors is additionally recommended.

Preferred anionic surfactants include both those based on petrochemicals, such as alkylbenzenesulfonates, alkanesulfonates or alkyl (ether) sulfates with odd-numbered chain lengths, and those based on native materials, for example fatty alkyl sulfates or fatty alkyl (ether) sulfates, soaps, sulfosuccinates etc. Alkylbenzenesulfonates and/or various chain cuts of alkyl sulfates or alkyl ether sulfates—optionally in combination with small amounts of soap—are particularly preferred. While in the case of alkylbenzenesulfonates the C11-C13-alkylbenzenesulfonate and C12-alkylbenzenesulfonate are preferred, in the case of the alkyl (ether) sulfates, preferred chain cuts are C12 to C16, C12 to C14, C14 to C16, C16 to C18 or C11 to C15 or C13 to C15.

Preferred nonionic surfactants include, in particular, the C12-C18-fatty alcohols ethoxylated with, on average, 1 to 7 mol of ethylene oxide per mole of alcohol, and the corresponding C11-C17-alcohols, in particular C13-C15-alcohols, but also the more highly ethoxylated alcohols of the given chain length known from the field of detergents or cleaners, amine oxides, alkyl polyglycosides, polyhydroxy fatty acid amides, fatty acid methyl ester ethoxylates and gemini surfactants.

Inorganic builders which are preferably used are, in particular, conventional phosphates, preferably tripolyphosphate, zeolites, with zeolite A, zeolite P, zeolite X and any mixtures of these, in particular, playing a role, but also carbonates, hydrogencarbonates, and crystalline and amorphous silicates with secondary detergency. Customary cobuilders include primarily (co)polymeric salts of (poly)carboxylic acids, for example copolymers of acrylic acid and of maleic acid, but also polycarboxylic acids and salts thereof, such as citric acid, tartaric acid, glutaric acid, succinic acid, polyaspartic acid etc. The person skilled in the art knows the organic cobuilders which can be used and their use amounts from numerous publications in the field of detergents and cleaners.

The bleaching agents used are primarily the peroxide bleaching agents customary at the time, such as perborate or percarbonate, especially also in combination with the current bleach activators and bleach catalysts, in particular in the field of dishwashing detergents, but also the active chlorine compounds already mentioned above.

In the case of the enzymes, not only proteases, but also lipases, amylases, cellulases and peroxidases, and any desired combinations of these enzymes are of particular interest.

In a preferred embodiment of the invention, anionic surfactant-containing compounds are used which comprise various anionic surfactants—for example alkyl sulfates and alkylbenzenesulfonates and/or soap or else alkyl sulfates and sulfated fatty acid glycerol esters—and/or anionic surfactants in combination with nonionic surfactants, for example alkyl sulfates of various chain lengths, optionally also several types of alkyl sulfates with various chain sections in combination with ethoxylated alcohols and/or other abovementioned nonionic surfactants. For example, anionic and nonionic surfactants may also be predominantly accommodated in two different compounds.

Suitable powdering agents which are optionally used are, as also in the case of the disintegrant granules, primarily finely divided zeolites, silicas, sulfates, calcium stearates, phosphates and/or acetates. In a preferred embodiment of the invention, it must be ensured that dust fractions and particles less than 0.2 mm are separated off as completely as possible prior to mixing with the disintegrant granules.

The PSI-containing shaped bodies according to the invention have, due to PEG and/or phosphoric acid, excellent disintegration properties and thus permit the use of PSI for the first time. This may be tested, for example, under critical conditions in a conventional domestic washing machine (insertion directly into the wash liquor by means of conventional dosing device, light-duty wash program or colored wash, wash temperature maximum 40° C.) or in a beaker at a wash temperature of 25° C.

The dissolution behavior of PSI-containing washing-active shaped bodies was investigated by means of fluorescence spectroscopy. For example, an aqueous solution of the polyaspartic acid prepared by thermal means following excitation with UV light with a maximum at 334 nm shows a fluorescence emission at 411 nm (in the maximum).

In a further embodiment of the invention, a washing process is therefore claimed where the shaped body comprising PSI and PEG and/or phosphoric acid is introduced into the wash liquor via the dispensing device of the domestic washing machine.

The actual manufacture of the shaped bodies according to the invention containing PSI and PEG and/or phosphoric acid is carried out by firstly mixing with the other constituents and then shaping, in particular compression to give tablets, possibly with recourse to conventional processes (for example as described in the conventional patent literature relating to tableting, especially in the field of detergents or cleaners, in particular as in the abovementioned patent applications and the article “Tablettierung: Stand der Technik” [Tableting: Prior art], SÖFW Journal, Volume 122, pp. 1016-1021 (1996)), the contents of which are hereby incorporated into the present application.

The washing or cleaning shaped bodies can be used in cleaning materials or substrates such as textiles. In washing or cleaning of textiles, the shaped bodies can be introduced into washing liquor in a washer which is preferably a washing machine. In the case of washing machines the shaped bodies are preferably introduced via a dispenser of the washing machines.

This and other aspects of the invention are further described by the

### EXAMPLES

Production of Partial Hydrolyzates of Polysuccinimide

Starting Material

A suspension was produced from 500 g of Baypure® DSP (PSI solid and pure) available from Bayer Chemicals AG and 615 g of water and homogenized in a rotor/stator mixer (X40/38 E2) at level 2. Then, depending on the desired degree of ring-opening, the corresponding quantity of NaOH (45%) was added slowly, so that a temperature of 50° C. was not exceeded (in a water bath). After cooling to room temperature, the pH value (see the table) was measured and the solution/suspension was atomized.

Granulation

Drying and granulation were carried out by gel permeation chromatography under the conditions listed in the table. After successive periods of about 30 minutes the process was interrupted and the deposits were removed from the wall and the base and optionally ground in a mortar mill. Then the remaining solution/suspension was atomized and the attempt was made to keep the production temperature as low as possible. The materials obtained were screened off via a 1 mm screen in order to remove very large agglomerates. In all of the tests the granulation was effective, although a high quantity of dust was also produced which suggests that the material dries quickly. Free-flowing materials were obtained which consisted of hard, brittle particles, which were for the most part smaller than 0.5 mm. The bulk density varied between 400 and 480 g/l, partially also due to the high content of dust. The lower the degree of ring-opening, the lower the product temperature which could be selected.

TABLE 1
Laboratory tests

| | Degree | | | | | | | Quantity |
|---|---|---|---|---|---|---|---|---|
| | of ring | Quantity | | Temperature | Temperature | Product | Atomization | after |
| Test | opening | of NaOH | pH | of ingoing | of exhaust | temperature | pressure | screening |
| no. | in % | in g | value | air ° C. | air ° C. | in ° C. | in bars | in g |
| V1 | 50 | 222 | 8.28 | 140 | 74-80 | 83-90 | 1.0 | 300 |
| V2** | 50 | 444 | 7.5 | 140 | 64-80 | 77-90 | 1.0 | 930 |
| V3 | 40 | 178 | 7.5 | 140 | 68-80 | 74-90 | 1.0 | 330 |
| V4 | 30 | 133 | 6.6 | 140 | 65-80 | 72-90 | 1.0 | 340 |

*Loss in weight on drying determined with an IR weighing machine at 160° C. over a period of 60 mins: 2.5 g
**When using tap water (with a degree of hardness of 17-18°) a somewhat higher viscosity of the DSP suspension was observed

The partial hydrolyzates display a neutral to acidic reaction after granulation (Produkt V3 produces for example a pH of 6.5 in a 4% solution in water).

For the dissolution behavior, compacts made of PSI and stearic acid (90:10) were compared with those made of PSI and alkyl polyethylene glycols (7-10 EO; 60:40). The latter disintegrate (manufactured using a low compressive force) in minutes in an aqueous dispersion in which PSI rapidly dissolves. The dissolution rate is particularly rapid in an alkaline environment, as is typical of detergent formulations.

The concentration as a function of time was determined using fluorescence spectroscopy (excitation 334 nm, fluorescence emission 411 nm), using the intrinsic fluorescence of the polyaspartic acid produced thermally from maleic anhydride and ammonia.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A washing- or cleaning-active shaped body, which comprises polysuccinimide (PSI) in combination with polyethylene glycols (PEG) and/or phosphoric acid.

2. The composition as claimed in claim 1, which comprises PSI in combination with PEG.

3. The composition as claimed in claim 1, which comprises PSI in combination with phosphoric acid.

4. The composition as claimed in claim 1, wherein PSI with an average molar weight of from 500 to 20 000 is used.

5. The composition as claimed in claim 1, wherein PEG is used in amounts of from 0.5 to 20% by weight.

6. The composition as claimed in claims 1, wherein phosphoric acid is used in amounts of from 0.5 to 25% by weight.

7. The composition as claimed in claim 1, wherein additional disintegrants are used.

8. The composition as claimed in claim 1, which comprises further constituents as are customarily used in detergents or cleaners and water softeners.

9. A process for the preparation of washing- or cleaning-active shaped bodies comprising PSI and PEG and/or phosphoric acid, which comprises firstly mixing the PSI with PEG and/or with phosphoric acid followed by mixing with the optional additional constituents and compressing the resulting mixture to give the shaped bodies which are optionally tablets.

10. A process for washing or cleaning substrates in need thereof comprising introducing washing or cleaning active shaped bodies comprising combination of PSI with PEG and/or phosphoric acid into a washing liquor containing the substrates.

11. A process for washing or cleaning subtrates comprising introducing a detergent comprising a shaped body as claimed in claim 1 in domestic washing machines.

12. A process for washing substrates comprising introducing the shaped body as recited in claim 1 into the wash liquor via a dispensing device of a washing machine.
